(19) United States
(12) Patent Application Publication
(10) Pub. No.: US 2009/0295670 A1
(43) Pub. Date: Dec. 3, 2009

(54) Flat antenna and antenna device

(75) Inventors: Feng-Chi Eddie Tsai, Taipei Hsien (TW); Yu-Chuan Su, Taipei Hsien (TW); Chin-Lung Yeh, Taipei Hsien (TW); Yin-Ping Wu, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: WISTRON NEWEB CORP., Taipei Hsien (TW)

(21) Appl. No.: 12/379,128

(22) Filed: Feb. 13, 2009

(30) Foreign Application Priority Data
Jun. 2, 2008 (TW) 097120443

(51) Int. Cl. H01Q 1/50

(52) U.S. Cl. 343/850; 333/167

(57) ABSTRACT

A flat antenna is used for a cable inputting a signal. The flat antenna comprises a base board, a radiator element, a filter unit, and a ground element wherein the radiator element, the filter unit, and the ground element are disposed on the board. The filter unit is used for eliminating or keeping the specific range of the frequency.

### BACKGROUND OF THE INVENTION

1. Field of the Invention

The present invention relates to an antenna, and, more particularly, to a flat antenna having a filter unit.

2. Description of the Related Art

In prior arts, an antenna device may be composed of several flat antennas for different frequency ranges, and the total frequency range is around 2 GHz to 6 GHz and recognized as a broadband antenna. The broadband antenna uses the particular shape and angle of the radiator of the flat antenna to receive and transmit broadband frequency signals.

For example, in a prior art antenna device, several flat antennas for 2.4 GHz and 5 GHz are alternatively disposed. However, when the flat antennas for 2.4 GHz and 5 GHz simultaneously receive and transmit signals, the two antennas for different frequencies, being in close proximity, have an interactive effect (such as electric wave interference or gain), which causes the data transmission of the flat antenna to have low efficiency.

Therefore, it is desirable to provide a flat antenna having a filter unit for eliminating or keeping the specific range of the frequency to mitigate and/or obviate the aforementioned problems.

### SUMMARY OF THE INVENTION

A main objective of the invention is to provide a flat antenna for eliminating or keeping a specific range of frequencies.

Another objective of the invention is to provide an antenna device that can eliminate or keep a specific range of frequencies.

In order to achieve the abovementioned objectives, a flat antenna of the invention is used for a cable inputting a signal. The flat antenna comprises a base board, a radiator element, a filter unit, and a ground element, wherein the radiator element, the filter unit, and the ground element are on the base board. The filter unit is used for eliminating or keeping the specific range of frequencies. An antenna device of the invention comprises a plurality of flat antennas and a reflecting board. Each flat antenna comprises a base board, a radiator element, a filter unit, and a ground element, wherein the radiator element, the filter unit, and the ground element are on the base board. The reflecting board is used for reflecting the radiation energy from the plurality of flat antennas. Furthermore, at least one flat antenna is a high frequency antenna, and at least one flat antenna is a low frequency antenna

According to the embodiment of the invention, the filter unit can be a band pass filter, a high pass filter, a low pass filter, or a band reject filter.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of an antenna device according to an embodiment of the invention.

FIG. 2 is a schematic drawing of a flat antenna in a first embodiment according to the invention.

FIG. 2A shows a radiation pattern of the antenna according to the first embodiment of the invention.

FIG. 3A and FIG. 3B are schematic drawings of the flat antenna in a second embodiment according to the invention.

FIG. 4A and FIG. 4B are schematic drawings of the flat antenna in a third embodiment according to the invention.

FIG. 5 is a schematic drawing of the flat antenna in a fourth embodiment according to the invention.

### DETAILED DESCRIPTION OF THE PREFERRED EMBODIMENT

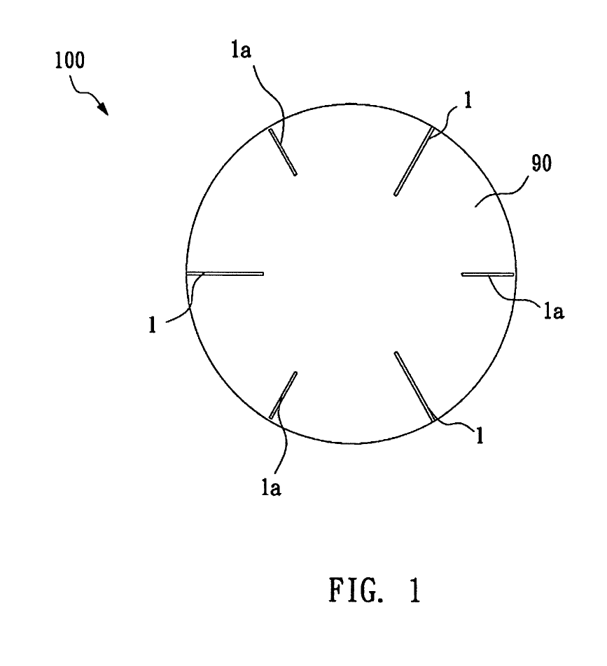

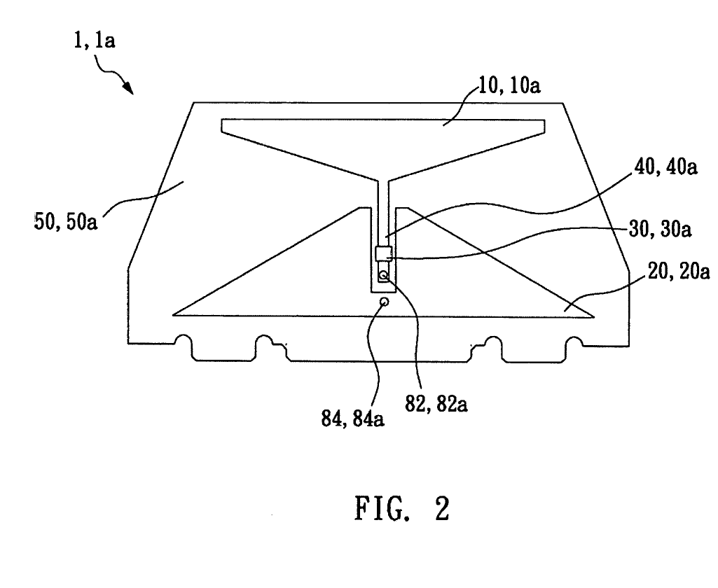

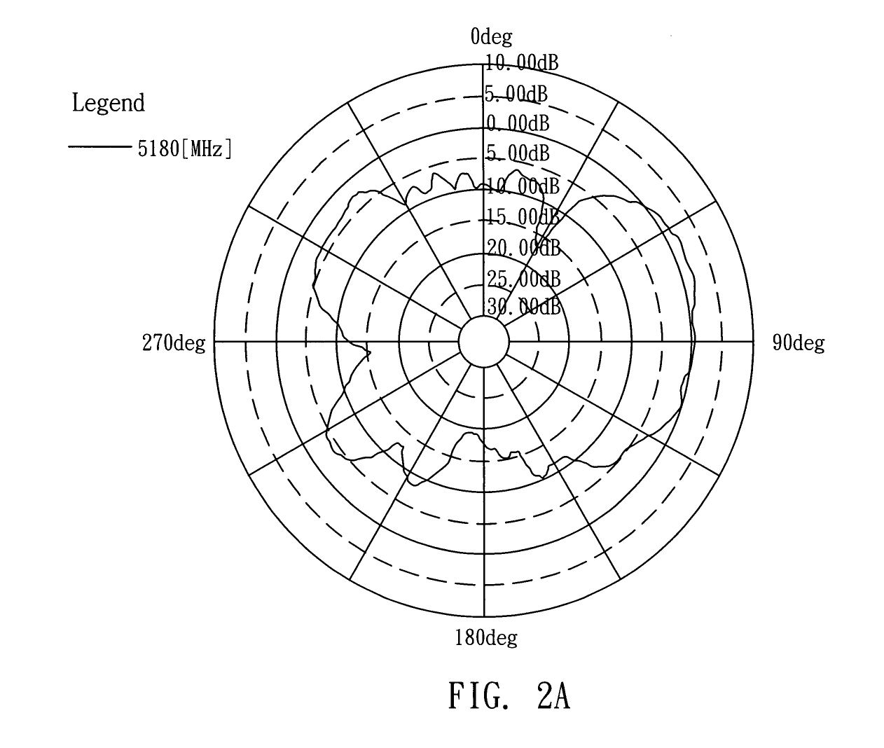

Please refer to FIG. 1 and FIG. 2 together. FIG. 1 is a schematic drawing of an antenna device according to the invention. FIG. 2 is a schematic drawing of a flat antenna in a first embodiment according to the invention. An antenna device 100 comprises a reflecting board 90, a plurality of flat antennas 1 and a plurality of flat antennas 1a. Furthermore, the reflecting board 90 is used for reflecting the radiation energy and is made of metal board or metal-plated board.

In this embodiment, a plurality of flat antennas 1 and a plurality of flat antennas 1a are alternatively disposed around the reflecting board 90. A plurality of flat antennas 1 and a plurality of flat antennas 1a are used for transmitting and receiving signals with different frequencies. For example, they can be antennas individually for receiving different frequencies 2.4 GHz and 5 GHz. In this embodiment, the antenna device 100 has three flat antennas 1 and three flat antennas 1a alternatively arranged therein.

Please refer to FIG. 2. The flat antennas 1 or 1a comprises a base board 50 or 50a, a radiator element 10 or 10a, a transmission unit 40 or 40a, a filter unit 30 or 30a, and a ground element 20 or 20a. In this embodiment, the radiator element 10 or 10a, the transmission unit 40 or 40a, and the filter unit 30 or 30a are all disposed on the same side of the base board 50 or 50a. However, the radiator element 10 or 10a and the ground element 20 or 20a can also be disposed on a different side of the base boards 50 or 50a.

Furthermore, the transmission unit 40 or 40a and the radiator element 10 or 10a are electrically connected together; the filter unit 30 or 30a and the transmission unit 40 or 40a are electrically connected together; and the ground element 20 or 20a and the transmission unit 40 or 40a are electrically connected together via the cable.

When a current passes through the radiator element 10 or 10a and the ground element 20 or 20a, it causes resonance to excite radiation energy, and the reflecting board 90 reflects the radiation energy to generate a radiation pattern for enabling the transmission capability of the antenna device 100. In this embodiment, the radiator element 10 or 10a and the ground element 20 or 20a are made of metal.

The filter unit 30 or 30a is electrically connected to the radiator element 10 or 10a via the transmission unit 40 or 40a. The filter unit 30 or 30a is used for eliminating or keeping the frequencies in a predetermined range. Moreover, the filter unit 30 or 30a is a band pass filter, a high pass filter, a low pass filter or a band reject filter.

In this embodiment, the transmission unit 40 or 40a is a coplanar waveguide (CPW) transmission unit. The filter unit 30 or 30a is a single filter chip and welded onto the transmission unit 40 or 40a. When the flat antenna 1 is a relative low frequency antenna (such as for 2.4 GHz), the filter unit 30 filters out the relative high frequency signals (which represents the band reject filter); or only allows the relative low frequencies to pass through (which represents the low pass filter). When the flat antenna 1a is the relative high frequency antenna (such as for 5 GHz), the filter unit 30a filters out the relative low frequency signals (which represents the band reject filter); or only allows the relative high frequencies to pass through (which represents the high pass filter).

Signals are inputted from the cable (not shown) to a feeding point 82 or 82a and a feeding point 84 or 84a. In this embodiment, the feeding point 82 or 82a is disposed at the end of the transmission unit 40 or 40a and used for enabling filaments of a power supply cable to feed signals; and the feeding point 84 or 84a is disposed on the ground element 20 or 20a and used for enabling the wire net of the power supply cable to feed signals.

Please refer to FIG. 2. The radiator element 10 or 10a has a strip-like shape, and the ground element 20 or 20a has a triangular shape. The transmission unit 40 or 40a extends from the end of the ground element 20 or 20a into the ground element 20 or 20a such that the ground element 20 or 20a surrounds the transmission unit 40 or 40a. There is a slight gap between the ground element 20 or 20a and the transmission unit 40 or 40a. In this embodiment, the filter unit 30 or 30a is disposed at a substantial center position of the ground element 20 or 20a.

FIG. 2A shows a radiation pattern of the antenna according to the first embodiment of the invention. During the operation of the filter units 30, 30a, the antenna has a better radiation pattern.

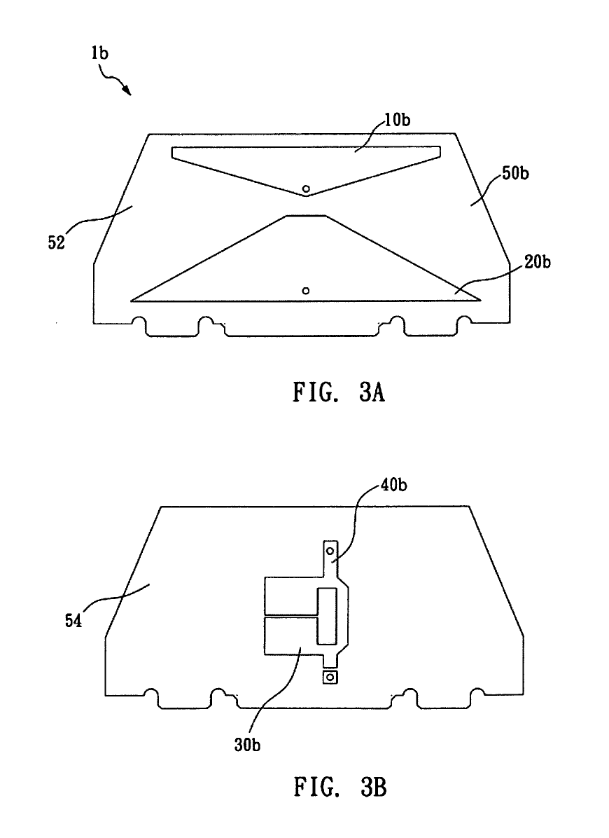

Please refer to FIG. 3A and FIG. 3B. FIG. 3A and FIG. 3B are schematic drawings of the flat antenna in a second embodiment according to the invention. Furthermore, FIG. 3A shows a first side 52 of the base board 50b, and FIG. 3B shows a second side 54 of the base board 50b.

The flat antenna 1b is a low frequency antenna (such as for 2.4 GHz) and comprises the base board 50b, the radiator element 10b, the transmission unit 40b, the filter unit 30b, and the ground element 20b. The difference between this embodiment and the first embodiment is that the filter unit 30b is a microstrip filter, the transmission unit 40b is a microstrip transmission line, and both of these are formed in printed circuit technology. Moreover, the filter unit 30b and the transmission unit 40b are disposed on the second side 54 of the base board 50b (as shown in FIG. 3B), and other elements are disposed on the first side 52 of the base board 50b (as shown in FIG. 3A).

Furthermore, the transmission unit 40b disposed on the second side 54 and the radiator element 10b and the ground element 20b disposed on the first side 52 are soldered to be electrically connected together.

Since the flat antenna 1b is a low frequency antenna, the filter unit 30b is used for filtering out the high frequency signals or keeping the low frequency signals.

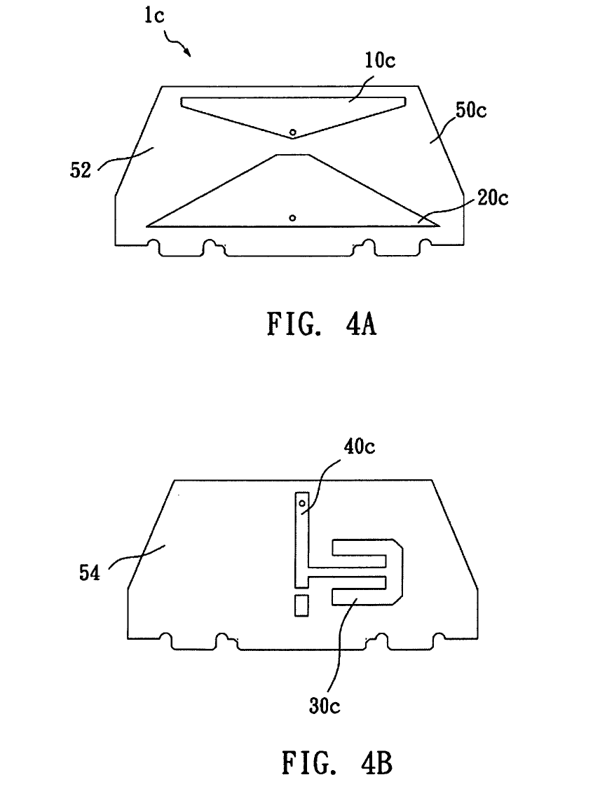

Please refer to FIG. 4A and FIG. 4B. FIG. 4A and FIG. 4B are schematic drawings of the flat antenna in a third embodiment according to the invention. FIG. 4A shows the first side 52 of the base board 50c, and FIG. 4B shows the second side 54 of the base board 50c.

The flat antenna 1c is a high frequency antenna (such as for 5 GHz), which comprises the base board 50c, the radiator element 10c, the transmission unit 40c, the filter unit 30c, and the ground element 20c. The filter unit 30c is a microstrip filter, the transmission unit 40c is a microstrip transmission line, and both of them are formed in printed circuit technology. Moreover, the filter unit 30c and the transmission unit 40c are disposed on the second side 54 of the base board 50c (as shown in FIG. 4B), and other elements are disposed on the first side 52 of the base board 50c (as shown in FIG. 4A).

The difference between this third embodiment and the second embodiment is that the flat antenna 1c is a high frequency antenna and the filter unit 30c is used for filtering out the low frequency signals or keeping the high frequency signals.

Furthermore, in the second or third embodiment, the filter unit 30b or 30c, the radiator element 10b or 10c and the ground element 20b or 20c can all be disposed on the same side of the base board 50b or 50c.

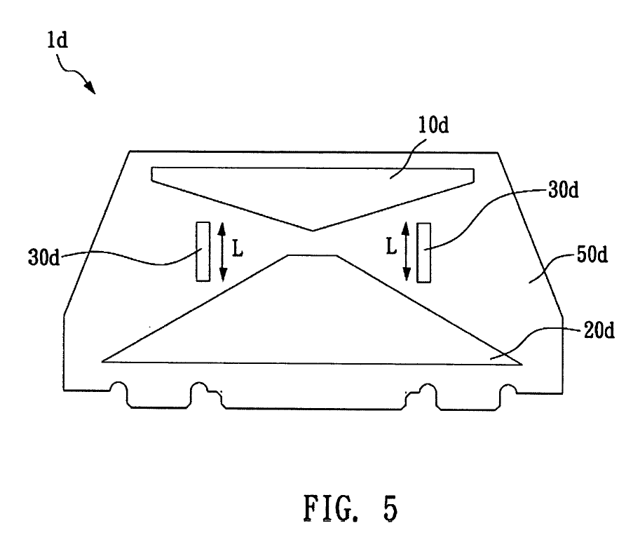

Please refer to FIG. 5. FIG. 5 is a schematic drawing of the flat antenna in a fourth embodiment according to the invention.

The filter unit 30d is two long strip cables disposed symmetrically between the ground element 20d and the radiator element 10d. In this embodiment, the radiator element 10d, the ground element 20d, and the filter unit 30d are disposed on the same side of the base board 50d. Moreover, the filter unit 30d utilizes the electrical induction method to filter out signals.

The length L of the filter unit 30d is less than ½ of the wave length of the signal frequency to be removed. In this embodiment, the length L of each filter unit 30d is substantially ¼ of the wave length of the signal frequency to be removed. Furthermore, when the flat antenna 1d is the high frequency antenna, the length L of each filter unit 30d is substantially ¼ of the wave length of the center frequency of the low frequencies; when the flat antenna 1d is the low frequency antenna, the length L of each filter unit 30d is substantially ¼ of the wave length of the center frequency of the high frequencies.

Although the present invention has been explained in relation to its preferred embodiment, it is to be understood that many other possible modifications and variations can be made without departing from the spirit and scope of the invention as hereinafter claimed.

What is claimed is:

1. A flat antenna for enabling a cable inputting a signal, the flat antenna comprising:
a base board;
a radiator element disposed on the base board;
a filter unit disposed on the base board, the filter unit being used for eliminating frequencies in a predetermined range or keeping frequencies in a predetermined range; and
a ground element disposed on the base board.

2. The flat antenna as claimed in claim 1, further comprising: a transmission unit disposed on the base board, and the transmission unit and the radiator element are electrically connected together.

3. The flat antenna as claimed in claim 2, wherein the filter unit is a band pass filter, a high pass filer, a low pass filter or a band reject filter.

4. The flat antenna as claimed in claim 3, wherein the filter unit is a flier chip.

5. The flat antenna as claimed in claim 4, wherein the transmission unit is a coplanar waveguide (CPW) transmission unit.

6. The flat antenna as claimed in claim 5, wherein the transmission unit is extended into the ground element such that the ground element surrounds around the transmission unit.

7. The flat antenna as claimed in claim 6, wherein the filter unit is disposed at a substantial center position of the ground element.

8. The flat antenna as claimed in claim 3, wherein the filter unit is a microstrip filter.

9. The flat antenna as claimed in claim 8, wherein the transmission unit is a microstrip transmission line.

10. The flat antenna as claimed in claim 9, wherein the radiator element is disposed on the front side of the base board, and the filter unit and the transmission unit are disposed on the back side of the base board.

11. The flat antenna as claimed in claim 3, wherein the radiator element has a strip-like shape, and the ground element has a triangular shape.

12. The flat antenna as claimed in claim 2, wherein the filter unit and the transmission unit are electrically connected together, and the ground element and the transmission unit are electrically connected together via the cable.

13. The flat antenna as claimed in claim 1, wherein the filter unit is two strip-shaped cables symmetrically disposed between the radiator element and the ground element, and the length of the filter unit is less than ½ of the wave length of a center frequency.

14. An antenna device comprising:
a plurality of flat antennas, each flat antenna comprising:
a base board;
a radiator element disposed on the base board;
a filter unit disposed on the base board, the filter unit being used for eliminating frequencies in a predetermined range or keeping frequencies in a predetermined range; and
a ground element disposed on the base board; and
a reflecting board for reflecting the radiation energy from the plurality of flat antennas;
wherein at least one flat antenna is a high frequency antenna and at least one flat antenna is a low frequency antenna.

15. The antenna device as claimed in claim 14, wherein the flat antenna further comprises a transmission unit disposed on the base board, and the transmission unit and the radiator element are electrically connected together.

16. The antenna device as claimed in claim 15, wherein the filter unit is a band pass filter, a high pass filter, a low pass filter, or a band reject filter.

17. The antenna device as claimed in claim 16, wherein the transmission unit is extended into the ground element such that the ground element surrounds around the transmission unit.

18. The antenna device as claimed in claim 16, wherein the filter unit is a microstrip filter.

19. The antenna device as claimed in claim 18, wherein the radiator element is disposed on the front side of the base board, and the filter unit and the transmission unit are disposed on the back side of the base board.

20. The antenna device as claimed in claim 14, wherein the filter unit is two strip-shaped cables symmetrically disposed between the radiator element and the ground element, and the length of the filter unit is less than ½ of the wave length of a center frequency.
